(19) United States
(12) Patent Application Publication
(10) Pub. No.: US 2005/0260536 A1
(43) Pub. Date: Nov. 24, 2005

(54) Optically amplified dental shade guide

(76) Inventors: Basilios Constantine Costaras, Westlake, OH (US); George Photios Pandis, Lakewood, OH (US)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/852,570

(22) Filed: May 24, 2004

(51) Int. Cl. A61C 19/10; A61C 3/00

(52) U.S. Cl. 433/26; 433/29; 15/167.1

(57) ABSTRACT

The present invention is directed to dental apparatus comprising an optical amplification device and a shade guide. The optical amplification device is integrated with the shade guide, wherein the optical amplification device is operable to generally magnify an image of a user's tooth for comparison with one or more distinct color shade specimens associated with the shade guide. The one or more color shade specimens are further associated with one or more respective tooth colors. The shade guide may further comprise an appliqué or one or more other objects coupled to the optical amplification device. The optical amplification device further comprises a generally convex side and a generally planar side, wherein the user's tooth, when viewed from the convex side through the generally planar side is generally optically magnified.

### FIELD OF THE INVENTION

The present invention relates generally to dental instruments, and more particularly, to an optically amplified dental shade guide.

### BACKGROUND OF THE INVENTION

In dentistry, tooth color is a concern for various reasons. For example, dental restoration devices such as caps, individual replacement teeth, or complete sets of dentures are typically manufactured in various shades of white in order to match a patient's existing teeth as closely as possible. In cosmetic dentistry, tooth-whitening has become highly fashionable, wherein a patient's existing teeth are lightened in color in order to provide a brighter or whiter smile. Consequently, specialized whitening products have been developed for use by dental professionals in a clinical environment, as well as for individual use by the patients themselves, using do-it-yourself whitening kits. In either case, tooth color is typically monitored throughout the whitening process in order to better quantify an amount of whitening that is taking place. Hence, tooth color shade guides have been developed to assist both dental professionals and patients in providing a more objective determination of tooth color.

Historically, a number of tooth color shade guides have been developed to facilitate the determination, or matching, of tooth color. For example, a dentist or other dental professional compares color shades on the shade guide to the patient's teeth in order to identify the color shade closest to the color of the patient's teeth. Over the years, an industry standard for tooth shades has been developed which encompasses a majority of human tooth shades. Consequently, the dental professional can compare and match a patient's currently-existing tooth color to a particular standardized shade in the large array of tooth color samples.

To facilitate the color comparison, tooth color shade guides conventionally include a number of separate or separable guides, with each guide having a distinct tooth color sample disposed thereon. In this way, the dental professional can individually view and compare a selected color shade against a patient's tooth. Each separate guide typically also has industry standard alpha-numeric characters assigned to the hue of the tooth color sample disposed thereon. This facilitates the dental professionals proper identification of the tooth color sample which most closely matches the patient's tooth color.

In the whitening process performed by a dental professional, for example, a patient's existing tooth color is altered over time, and as a part of the whitening treatment, it is advantageous for the dental practitioner to monitor the patient's tooth color throughout the process. Such monitoring typically comprises a general identification or determination of the patient's tooth color, typically for purposes of modifying the whitening treatment. Conventionally, it is advantageous for this monitoring to occur on a substantially frequent basis, which is typically more frequent than a patient or dental professional would like to schedule office visits.

Although the conventional tooth color shade guides utilized by the dental practitioner could be used by the patient to monitor the tooth whitening process, these conventional guides are relatively expensive and difficult for in-home use by the patient. As previously discussed, conventional tooth color shade guides typically include a large variety of tooth color samples so as to enable a precise match with the patient's tooth color. Typically, the large number of colors or shades consequently increases the cost of the conventional guides. Non-disposable guides, such as those discussed above, further have increased manufacturing costs and are can be prohibitively expensive when considering distribution to each patient.

As an alternative to the professional non-disposable shade guides, disposable shade guides have been developed for in-home use by patients undergoing tooth whitening. The typical shade guide, for example, is comprised of a slip of paper or other thin film, whereon a limited number of tooth color shades have been printed. Such guides are generally inexpensive, thus further allowing tooth-whitening product manufacturers to include the disposable shade guide in the packaging of their products. These conventional disposable shade guides, however, can be easily misplaced or mistakenly disposed of, thus hindering the comparison of tooth shades until a new shade guide is procured (typically by the purchase of another tooth whitening product).

Therefore, a need exists for a dental apparatus for comparing tooth color, wherein the apparatus is both economical and easy to use by both dental professionals and patients.

### SUMMARY OF THE INVENTION

The present invention overcomes the limitations of the prior art. Consequently, the following presents a simplified summary of the invention in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

The present invention is directed generally toward a dental apparatus for use in identifying a user's tooth color. The dental apparatus comprises a shade guide comprising one or more distinct color shade specimens, wherein the one or more distinct color shade specimens are generally associated with one or more respective standardized tooth colors. The dental apparatus further comprises an optically clear optical amplification device integrated with the shade guide, wherein the optical amplification device generally magnifies an image of an object, such as a user's tooth, for easy comparison with the one or more color shade specimens. The optical amplification device, for example, comprises a generally convex surface and an opposite, generally planar second surface, wherein the object, when viewed from the convex side through the planar side is generally magnified, and wherein the object can be compared to the one or more color shade specimens associated with the shade guide.

According to one exemplary aspect of the invention, the shade guide comprises an appliqué associated with a surface of the optical amplification device, such as the planar surface or the convex surface, wherein the appliqué comprises the one or more color shade specimens integrated therewith. The appliqué, for example, comprises a foil sheet or a film, wherein the foil sheet or film is adhered to the surface of the optical amplification device by an adhesive layer. The foil sheet or film further comprises the one or more color shade specimens associated therewith. The one or more color shade specimens, for example, are comprised of one or more of ink, paint, and dye.

In accordance with another exemplary aspect of the invention, the one or more color shade specimens comprise one or more respective objects that are embedded into the optical amplification device. The one or more objects, for example, comprise one or more of color chips, tooth replicas, or other objects which are associated with the one or more standardized tooth colors.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1A is a plan view of a dental apparatus having a shade guide associated therewith in accordance with one exemplary aspect of the present invention.

FIG. 1B is a front elevation view of the dental apparatus of FIG. 1A.

FIGS. 2A-2C are plan views of other exemplary dental apparatuses illustrating various shade guides according to another exemplary aspect of the present invention.

FIG. 3A is a plan view of another exemplary dental apparatus according to another aspect of the present invention.

FIG. 3B is a front elevation view of the dental apparatus of FIG. 3A.

FIG. 3C is a side elevation view of the dental apparatus of FIG. 3A.

FIG. 4A if a plan view of yet another exemplary dental apparatus according to another aspect of the present invention.

FIG. 4B is a front elevation view of the dental apparatus of FIG. 4A.

FIG. 4C is a side elevation view of the dental apparatus of FIG. 4A.

FIG. 5 is a plan view of still another dental apparatus according to another exemplary aspect of the present invention.

FIGS. 6A-6C are plan views of another dental apparatus having a retractable shade guide in accordance with another exemplary aspect of the present invention.

FIG. 7 is a plan view of another exemplary dental apparatus in accordance with yet another aspect of the present invention.

FIG. 8A is a perspective view of another dental apparatus according to another exemplary aspect of the present invention.

FIG. 8B is a side elevation view of the dental apparatus of FIG. 8A.

FIG. 9 is a perspective view of an exemplary dental apparatus in operation, according to another exemplary aspect of the present invention.

### DETAILED DESCRIPTION OF THE INVENTION

The present invention is directed generally towards a dental apparatus for determining tooth color. More particularly, the dental apparatus comprises a toothbrush, wherein the a shade guide is operably coupled thereto. Accordingly, the present invention will now be described with reference to the drawings, wherein like reference numerals are used to refer to like elements throughout. It should be understood that the description of these aspects are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details.

Several aspects of various exemplary dental apparatuses will now be provided in greater detail. It should be noted, however, that the dental apparatuses illustrated in the Figures are not necessarily drawn to scale, and that various features may or may not be shown for purposes of clarity. Therefore, it shall also be understood that the various features illustrated in the Figures can be of various shapes and sizes, or excluded altogether, and all such shapes, sizes, and exclusions are contemplated as falling within the scope of the present invention.

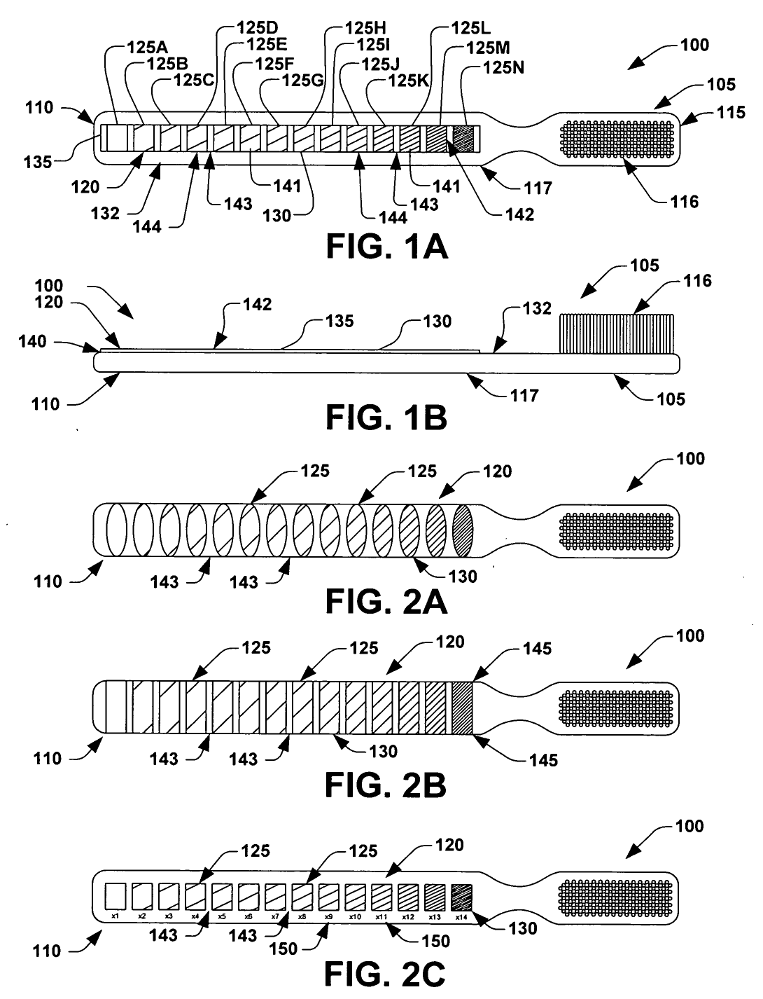

In accordance with a first embodiment of the present invention, an exemplary dental apparatus 100 is illustrated in FIGS. 1A and 1B, wherein the dental apparatus comprises a toothbrush 105. The toothbrush 105 generally comprises a handle portion 110 and a brush portion 115, wherein the brush portion 115 further comprises a plurality of bristles 116 coupled thereto. In one example, the brush portion 115 is fixedly coupled to the handle portion 110, wherein the handle portion 110 and brush portion jointly comprise a contiguous body 117. Alternatively, the handle portion 110 and brush portion 115 are operably coupled to one another, wherein the brush portion is operable to move with respect to the handle portion (e.g., such as in a motorized toothbrush).

In accordance with the present invention, the dental apparatus 100 further comprises a shade guide 120 operably coupled to the handle portion 110 of the toothbrush 105, wherein the shade guide 120 generally comprises one or more distinct color shade specimens 125 (e.g., illustrated as specimens 125A-125N in FIGS. 1A and 1B). The one or more distinct color shade specimens 125 are generally representative of one or more respective standardized tooth color shades typically used in determining a color shade of a person's teeth. While a particular number of color shade specimens 125 are illustrated in the Figures, any number of color shade specimens can be provided, and are further contemplated as falling within the scope of the present invention.

In accordance with one exemplary aspect of the present invention, the shade guide 120 of FIGS. 1A and 1B comprises an appliqué 130 associated with a surface 132 of the handle portion 110. According to one example, the appliqué 130 comprises a film 135 which is coupled to the surface 132 of the handle portion 110 by an adhesive layer 140 disposed between the film and the surface. The adhesive layer 140 comprises any conventional adhesive operable to generally adhere the appliqué 130 to the surface 132 of the handle portion 110. Wherein the dental device 100 comprises a toothbrush 105, however, the adhesive layer 140 preferably comprises a moisture-resistant adhesive, such that exposure to moisture (e.g., saliva and/or water) during use of the dental device does not substantially affect the adhesion of the appliqué 130 to the handle portion 110.

The appliqué 130 comprises the one or more color shade specimens 125, wherein the one or more color shade specimens are generally defined by one or more of ink, paint, and dye 141. According to one example, the film 135 is generally comprised of a polymer or plastic sheet, wherein the ink, paint, and/or dye 141 representing the one or more color shade specimens 125 is screen printed onto a surface 142 thereof. According to another example, the film 135 is generally optically clear, therein defining generally optically clear spaces 143 between the specimens 125. Alternatively, the film 135 is generally comprised of a foil sheet, such as a thin sheet of metal. The foil sheet, for example, is embossed or de-bossed in one or more regions 144 associated with the one or more color shade specimens 125, wherein the ink, paint, and/or dye 141 representing the one or more distinct color shade specimens 125 is generally disposed on the respective one or more regions. In another alternative, the one or more regions 144 each comprise a separate film 135.

According to another exemplary aspect of the invention, the handle portion 110 is comprised, at least in part, of an optically clear material, such as plastic, thermoplastic, or acrylic. Therefore, a user of the dental device 100 is able to see through the optically clear spaces 143 between the one or more color shade specimens 125, and further through the handle portion 110, to an object (not shown) behind the handle portion, such as the user's teeth. Such a visual path is advantageous in comparing the user's teeth to the one or more color shade specimens 125, wherein the user can easily determine the closest match between the appropriate color shade specimen and his or her own tooth color.

Furthermore, the size and shape of the one or more color shade specimens 125 can vary, and all such sizes and shapes are contemplated as falling within the scope of the present invention. For example, the color shade specimens 125 of FIGS. 1A and 1B illustrate generally rectangular specimens. FIG. 2A, for example, illustrates generally ovular color shade specimens 125. The ovular specimens 125 of FIG. 2A, for example, generally provide a larger space 143 between specimens, therein generally permitting a greater area for viewing the user's teeth through the handle portion 110. As illustrated in FIG. 2B, the color shade specimens 125 are again generally rectangular in shape, and generally cover the handle portion 110 between sides 145 of the handle portion. Such a configuration, for example, further allows the user to compare his or her teeth with the color shade specimens 125 along the sides 145 of the handle portion 110, as well as through the spaces 143. The handle portion 110 as illustrated in FIG. 2B, for example, is alternatively comprised of an opaque or colored material, wherein the user generally compares his or her teeth to the color shade specimens 125 only along the sides 145 of the handle portion. The shade specimens 125 illustrated in FIGS. 2A-2C may further comprise one or more distinct appliqués 130, or other objects, as will be further discussed infra.

Alternatively, the shade guide 120 comprises a generally hollow sheath (not shown), wherein the one or more color shade specimens 125 are comprised therein, wherein the sheath is operably coupled to the handle portion 110 (e.g., the sheath encases the handle portion). For example, the sheath comprises a generally hollow tube, wherein the sheath is coupled to the handle portion 110 by sliding the handle portion through the tube. The sheath may be further coupled to the handle portion 110 with or without an adhesive layer 140. As such, the sheath may comprise a generally flexible and/or resilient appliqué 130, or may be a generally rigid tube, and may also be fixedly coupled or removably coupled to the handle portion 110. In the case of a flexible sheath, a stretching of the sheath, for example, is operable to selectably fix the sheath to the handle portion 110.

FIG. 2C illustrates another exemplary aspect of the present invention, wherein the shade guide 120 further comprises one or more indicia 150 associated with each of the one or more color shade specimens 125. The one or more indicia 150, for example, generally permit the user to identify the particular color shade specimen 125 which closest matches his or her teeth, in order to relay the matched color shade to, for example, a dental professional. Likewise, the user can take note of the indicia during a tooth whitening process in order to quantify an amount of whitening that has occurred in his or her teeth. The one or more indicia 150, for example, comprise one or more characters or numbers which the user can use to identify or quantify his or her tooth color. According to another example, the one or more indicia are printed in a mirror-image, or backward orientation, such that the indicia are readable when viewed in a mirror.

In accordance with another exemplary aspect of the invention, the shade guide 120 comprising the one or more color shade specimens 125 and/or the one or more indicia illustrated in FIGS. 1A-1B and 2A-2C are screen printed or otherwise formed directly on the surface 132 of the handle portion 110, wherein the shade guide is generally comprised of one or more of ink, paint, and dye, thus defining the one or more distinct color shade specimens 125. Again, the handle portion 110 may be optically clear, colored, or otherwise opaque.

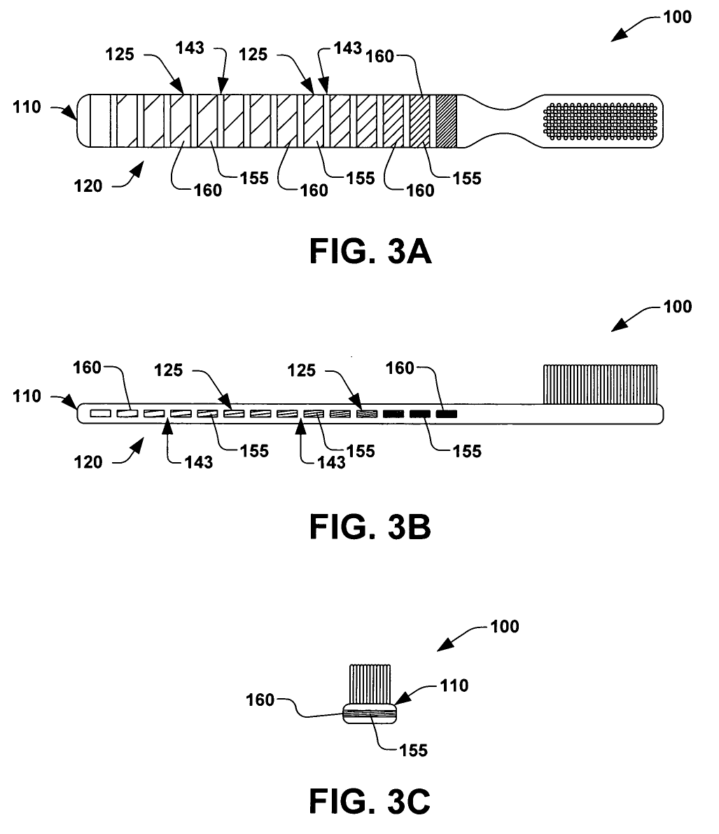

According to another embodiment of the present invention, as illustrated in respective plan, elevation, and side elevation views in FIGS. 3A-3C, the one or more color shade specimens 125 of the shade guide 120 comprise one or more objects 155 that are generally embedded in the handle portion 110 of the dental device 100. For example, the one or more objects 155 are embedded into the handle portion 110 during the formation of the handle portion (e.g., during a molding of a handle portion comprised of a thermoplastic material). The one or more objects 155, for example, comprise one or more respective color chips 160, wherein the one or more color chips are generally representative of one or more respective standard tooth shades. The one or more color chips 160, as stated above, can be separated from one another by optically clear spaces 143, wherein the user is again able to compare his or her teeth with the one or more color chips through the handle portion 110. The one or more color chips 160 can be rectangular, as illustrated in FIGS. 3A-3C, and can be comprised of any material known in the art, so long as the color shade of the individual color chips is distinct and recognizable. Furthermore, the color chips 160 may be of any shape or size, and all such shapes, sizes, and materials are contemplated as falling within the scope of the present invention. According to still another example, the one or more objects 155 comprises a panel (not shown), wherein the panel comprises the one or more color shade specimens, and wherein the panel is further embedded in the handle portion 110 of the dental apparatus 110.

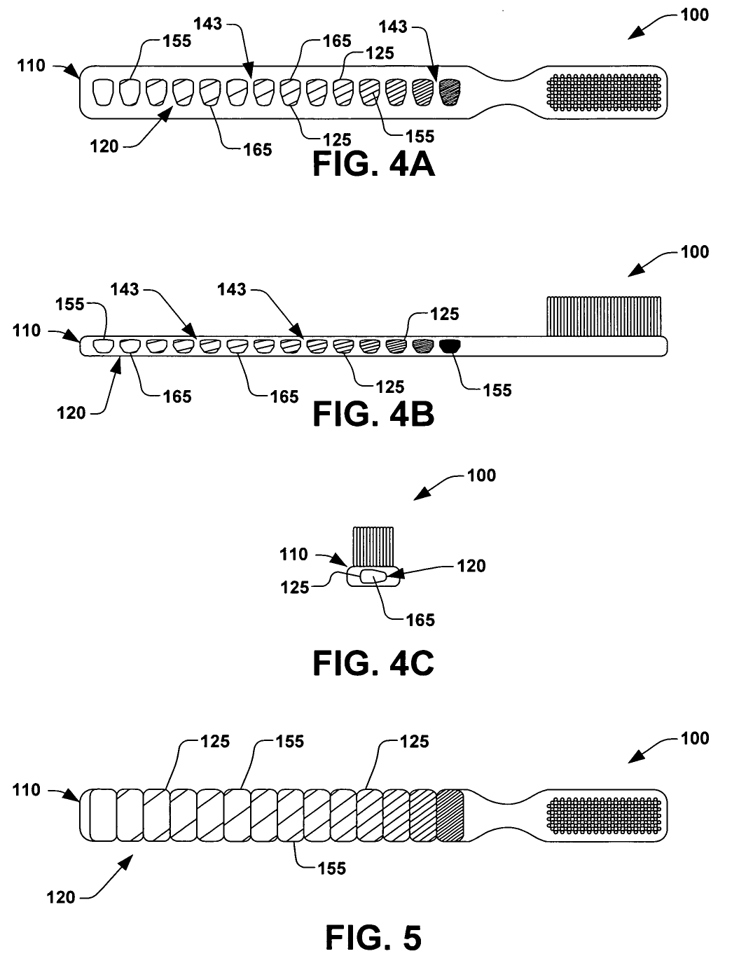

In accordance with another exemplary aspect of the invention, the one or more objects 155 comprise one or more tooth replicas 165, as illustrated in FIGS. 4A-4C. The one or more color shade specimens 125 of the shade guide 120 are generally represented by the respective one or more tooth replicas 165, wherein the one or more tooth replicas generally represent one or more respective tooth shades. The one or more tooth replicas 165, for example, are formed in the shape of a human tooth, and are embedded within the handle portion 110 of the dental apparatus 100. Again, the handle portion 110 is optically clear, wherein the user is able to visually compare his or her tooth color to the one or more tooth replicas 165 through the handle portion via the spaces 143. It should further be understood that any object 155 representative of a tooth shade may be embedded into the handle portion 110, and all such objects are contemplated as falling within the scope of the present invention. For example, FIG. 5 illustrates a handle portion 110 comprised of one or more objects 155, wherein each object is associated with the respective one or more color shade specimens 125. The one or more objects 155 are generally coupled to one another, thus forming the handle portion 1 1.0 of the dental apparatus 100.

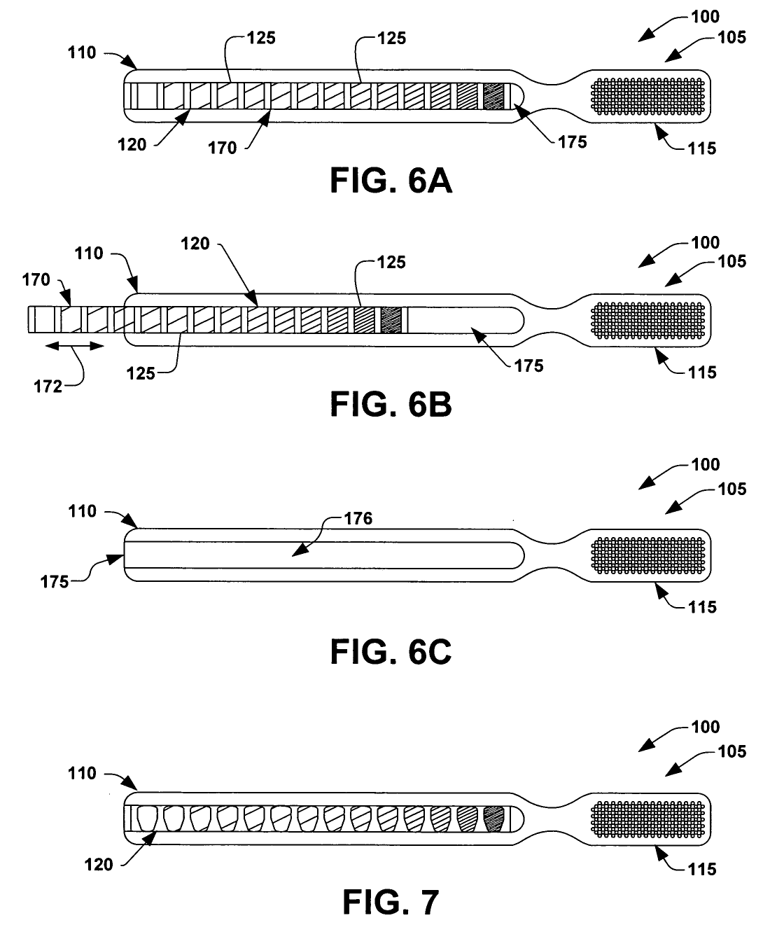

FIGS. 6A-6C illustrate still another embodiment of the present invention, wherein the shade guide 120 is retractably coupled to the handle portion 110. FIGS. 6A and 6B, for example, illustrate the dental apparatus 100, wherein the shade guide 120 generally resides within the handle portion 110, and wherein the shade guide is operable to extend and retract from the handle portion. For example, the shade guide 120 comprises a retractable member 170 having the one or more color shade specimens 125 disposed thereon, and wherein the retractable member is moveable and operable to be translated with respect to the handle portion 110 (e.g., as illustrated by arrows 172 in FIG. 6B). In one example, the retractable member 170 is retractably coupled to the handle portion 110 by a spring (not shown), wherein the spring generally provides a tension force which generally permits a retraction of the shade guide 120 within the handle portion 110.

In one example, the handle portion 110 comprises a generally hollow portion 175, wherein the retractable member 170 is operable to extend from, and retract to, the hollow portion of the handle portion. FIG. 6C illustrates the dental apparatus 100, wherein the shade guide has been removed from the hollow portion 175 of the handle portion 110. The hollow portion 175, for example, comprises a blind longitudinal hole 176 through the handle portion 110, wherein the handle portion can be either generally optically clear, wherein the user can view his or her teeth through the handle portion, or the handle portion may be colored or opaque, wherein the user extends the shade guide 120 from the handle portion in order to compare his or her teeth to the one or more color shade specimens 125. Alternatively, the hollow portion 175 comprises a track (not shown) within the handle portion 110, wherein the shade guide 120 is generally retained therein.

According to another exemplary aspect of the invention, as illustrated in FIG. 7, the retractable shade guide 120 comprising the one or more color shade specimens 125 further comprises one or more tooth replicas 155, as discussed above. Furthermore, the shade guide 120 may comprise any combination of appliqués, color chips, and/or tooth replicas as discussed above, and all such combinations are contemplated as falling within the scope of the present invention.

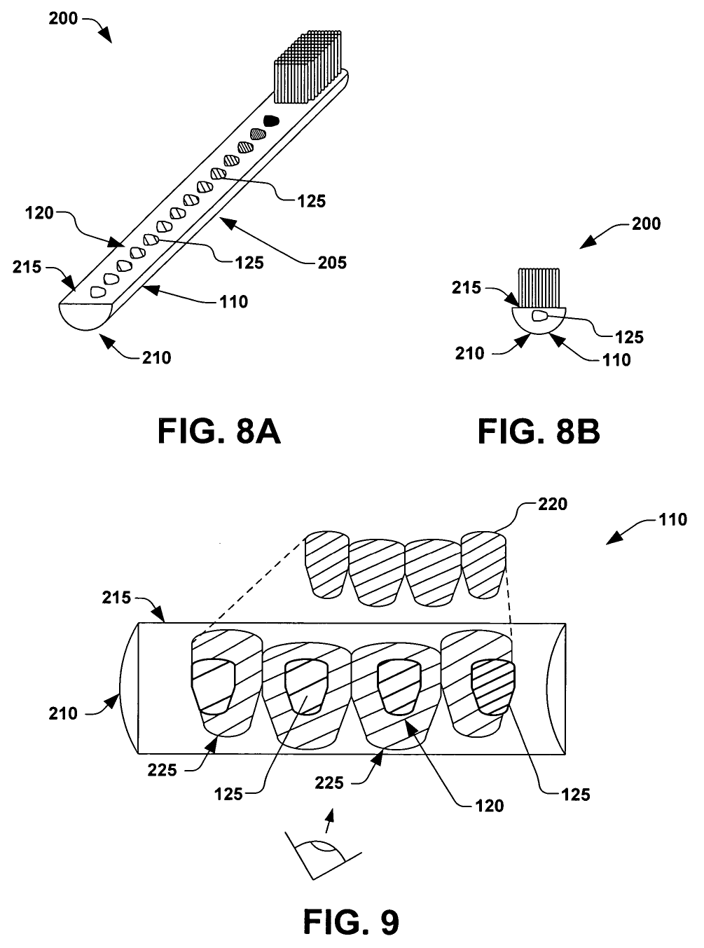

In accordance with yet another embodiment of the present invention, FIGS. 8A and 8B illustrate another exemplary dental apparatus 200, wherein the handle portion 110 further comprises an optical amplification device 205 wherein the optical amplification device, for example, comprises a generally convex first side 210 (e.g., a first surface), and a generally planar second side 215 (e.g., a second surface). Furthermore, the handle portion 110 is generally optically clear, wherein the optical amplification device 205 generally provides an optical magnification of an object (not shown) proximate to the second side 215. The handle portion 110 further comprises the shade guide 120 associated therewith, wherein a comparison between the one or more color shade specimens 125 can be compared to a magnified image of the user's teeth, when the user's teeth are generally proximate to the second side 215 of the dental apparatus 200. FIG. 9 illustrates the handle portion 110, wherein an object 220 (e.g., a user's teeth) is magnified through the handle portion, thus providing a magnified image 225 through the handle portion. The magnified image 225, for example, can be compared to the one or more color shade specimens 125 associated with the handle portion 110, wherein the user can closely match his or her own teeth image to the one or more color shade specimens.

According to another embodiment of the present invention, the dental apparatus 200 of FIGS. 8A, 8B, and 9 is provided without the brush portion 115, wherein the shade guide 120 can be utilized to magnify an image of a user's teeth. Such a dental apparatus 200, for example, can be used by both consumers and dental professionals, alike, wherein the user's existing tooth color can be compared to the one or more color shade specimens 125 for the purpose of determining tooth color. Such a determination is useful, for example, in a professional tooth-whitening process, wherein the dental professional adjusts the process, based, at least in part, on the patient's current tooth color. The dental apparatus 200, for example, can be easily stowed in a drawer, or the like, and can comprise a large variation in standardized tooth color shades. Alternatively, several different dental apparatuses 200, each comprising a different set of tooth color shades, can be utilized by the dental professional. The dental apparatus 200 of the present invention comprising the shade guide 120 is advantageous over other conventional shade guides, since the dental apparatus of the present invention is generally integrated into a unitary component, and is generally durable and sanitary.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

1. A dental apparatus, comprising:
a shade guide comprising one or more distinct color shade specimens associated with one or more respective tooth colors; and
an optical amplification device integrated with the shade guide, wherein the optical amplification device generally magnifies an image of a user's tooth for comparison with the one or more color shade specimens.

2. The dental apparatus of claim 1, wherein the shade guide comprises an appliqué associated with a surface of the optical amplification device, wherein the appliqué comprises the one or more color shade specimens integrated therewith.

3. The dental apparatus of claim 2, wherein the appliqué is comprised of a foil sheet which is adhered to the surface of the optical amplification device.

4. The dental apparatus of claim 2, wherein the appliqué is comprised of one or more of ink, paint, and dye which resides on a film, wherein the film is adhered to the surface of the optical amplification device.

5. The dental apparatus of claim 2, wherein the appliqué is selectively removable from the surface of the optical amplification device.

6. The dental apparatus of claim 2, wherein the shade guide comprises one or more of ink, paint, and dye applied directly to the surface of the optical amplification device.

7. The dental apparatus of claim 1, wherein the one or more color shade specimens comprise one or more respective objects embedded into the optical amplification device.

8. The dental apparatus of claim 7, wherein the one or more objects comprise one or more color chips.

9. The dental apparatus of claim 7, wherein the one or more objects comprise one or more tooth replicas.

10. The dental apparatus of claim 1, wherein the shade guide further comprises one or more indicia associated with each of the one-or more distinct color shade specimens.

11. The dental apparatus of claim 10, wherein each of the one or more indicia comprise one or more characters or numbers.

12. The dental apparatus of claim 11, wherein one or more of the one or more indicia are printed in a backward orientation, so as to be readable when viewed in a mirror.

13. The dental apparatus of claim 1, wherein the optical amplification device is comprised of an optically clear material.

14. The dental apparatus of claim 13, wherein the optically clear material comprises a thermoplastic material.

15. The dental apparatus of claim 13, wherein the one or more color shade specimens are embedded into the optical amplification device.

16. The dental apparatus of claim 1, wherein the optical amplification device is generally optically clear, and further comprises a convex first surface and generally planar second surface, wherein the tooth, when viewed from the convex first surface through the planar second surface is generally magnified.

17. The dental apparatus of claim 16, wherein the shade guide generally resides proximate to one of the first surface and the second surface, and wherein the shade guide is visible through the first surface of the optical amplification device.

18. The dental apparatus of claim 16, wherein the shade guide is generally embedded within the optical amplification device, and wherein the shade guide is visible through the first surface of the optical amplification device.
